(19) United States
(12) Patent Application Publication
(10) Pub. No.: US 2025/0077151 A1
(43) Pub. Date: Mar. 6, 2025

(54) INFORMATION PROCESSING DEVICE, METHOD FOR CONTROLLING THE SAME, AND PRINTING SYSTEM

(71) Applicant: CANON KABUSHIKI KAISHA, Tokyo (JP)

(72) Inventor: Ritsuto Sako, Tokyo (JP)

(21) Appl. No.: 18/818,916

(22) Filed: Aug. 29, 2024

(30) Foreign Application Priority Data
Sep. 5, 2023 (JP) 2023-143919

(51) Int. Cl. G06F 3/12

(52) U.S. Cl. CPC G06F 3/1288; G06F 3/1222; G06F 3/1238

(57) ABSTRACT

An information processing device having an operating system (OS) standard printing function, the information processing device includes a display unit configured to display information regarding a cloud printer registered in the OS standard printing function, and a print unit configured to instruct a cloud printer registered in the OS standard printing function to perform printing. While a first user is logged in to the information processing device, the display unit displays information regarding a cloud printer registered in the OS standard printing function by the first user. While a second user different from the first user is logged in to the information processing device, the display unit does not display information regarding a cloud printer registered in the OS standard printing function by the first user and not registered in the OS standard printing function by the second user.

### BACKGROUND OF THE INVENTION

### Field of the Invention

The present invention relates to an information processing device, a method for controlling the same, and a printing system.

### Description of the Related Art

A cloud print service that uses a cloud has been proposed (Japanese Patent Laid-Open No. 2014-139823). A print server defines a cloud printer corresponding to a physical printing device and provides the cloud printer to an information processing device. The print server receives a print instruction for the cloud printer from the information processing device, and instructs the printing device corresponding to the cloud printer to perform printing. The information processing device that uses the cloud printer may be shared among a plurality of users. In order for a user to use the cloud printer, it may be necessary for the user to log in to the cloud print server. Therefore, the cloud printer registered in the information processing device by one user may not necessarily be available to another user.

### SUMMARY OF THE INVENTION

Some aspects of the present invention provide a technique for preventing unnecessary information regarding a cloud printer from being displayed.

According to some embodiments, an information processing device having an operating system (OS) standard printing function, the information processing device comprising: a display unit configured to display information regarding a cloud printer registered in the OS standard printing function; and a print unit configured to instruct a cloud printer registered in the OS standard printing function to perform printing, wherein while a first user is logged in to the information processing device, the display unit displays information regarding a cloud printer registered in the OS standard printing function by the first user, and while a second user different from the first user is logged in to the information processing device, the display unit does not display information regarding a cloud printer registered in the OS standard printing function by the first user and not registered in the OS standard printing function by the second user is provided.

Further features of the present invention will become apparent from the following description of exemplary embodiments with reference to the attached drawings.

### BRIEF DESCRIPTION OF THE DRAWINGS

FIG. 1 is a schematic diagram illustrating an example of a configuration of a printing system according to some embodiments.

FIG. 2 is a block diagram illustrating an example of a hardware configuration of a computer according to some embodiments.

FIG. 3 is a block diagram illustrating an example of a functional configuration of a print server according to some embodiments.

FIG. 4 is a block diagram illustrating an example of a functional configuration of an information processing device according to some embodiments.

FIG. 5 is a block diagram illustrating an example of a hardware configuration of a printing device according to some embodiments.

FIG. 6 is a block diagram illustrating an example of a functional configuration of a printing device according to some embodiments.

FIG. 7 is a sequence diagram illustrating overall cloud print processing according to some embodiments.

FIG. 8 is a sequence diagram illustrating overall local print processing according to some embodiments.

FIG. 9 is a flow chart illustrating an example of a printer search method according to some embodiments.

FIG. 10 is a schematic diagram illustrating an example of a screen displayed by a standard printing function according to some embodiments.

FIGS. 11A and 11B are schematic diagrams illustrating examples of screens displayed by a standard printing function according to some embodiments.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Example of Configuration of Printing System

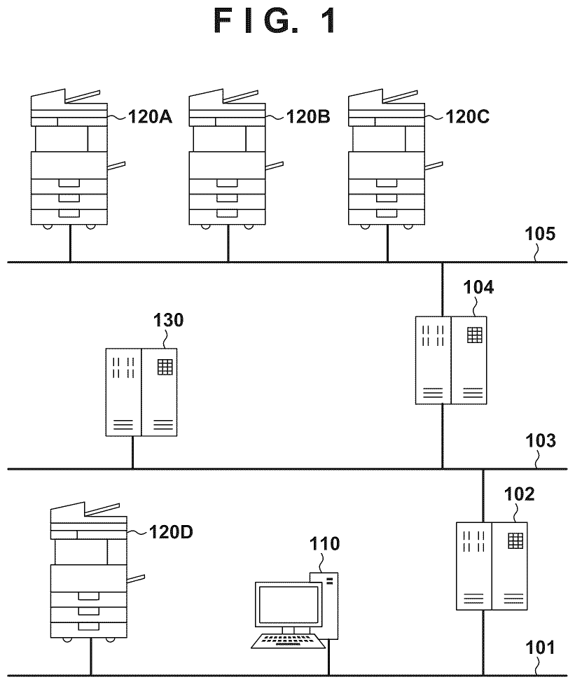

An example of a configuration of a printing system according to some embodiments will be described with reference to FIG. 1. The printing system includes, for example, an information processing device 110, printing devices 120A to 120D, and a print server 130. The number of components of the printing system is not limited to that shown in the example in FIG. 1. In addition, the printing system may also include components not shown in FIG. 1.

The information processing device 110 and the printing device 120D are connected to the same local area network (LAN) 101. The LAN 101 may be a wired LAN, a wireless LAN, or a combination of them. The LAN 101 is connected to a wide area network 103 (e.g., the Internet) via a firewall 102. A print server 130 is also connected to the wide area network 103. The information processing device 110 and the printing device 120D can communicate with each other within the LAN 101 (i.e., without using the wide area network 103). The information processing device 110 and the printing device 120D can communicate with the print server 130 via the LAN 101, the firewall 102, and the wide area network 103. Alternatively, or additionally, the information processing device 110 and the printing device 120D may be connected to the wide area network 103 via a cellular network (e.g., a network conforming to the fourth generation communication standard (4G) or the fifth generation communication standard (5G)).

The printing devices 120A to 120C are connected to the same LAN 105. The LAN 105 may be a wired LAN, a wireless LAN, or a combination of them. The LAN 105 is connected to the wide area network 103 via a firewall 104. The LAN 105 is a different LAN from the LAN 101. The printing devices 120 A to 120 C can communicate with the print server 130 via the LAN 105, the firewall 104, and the wide area network 103. Alternatively, or additionally, the printing devices 120A to 120C may be connected to the wide area network 103 via a cellular network. The information processing device 110 can communicate with the printing devices 120A to 120C via the LANs 101 and 105, the firewalls 102 and 104, and the wide area network 103. In the example in FIG. 1, the printing devices 120A to 120C are connected to the same LAN 105, but they may be connected to separate LANs.

The printing devices 120A to 120D have a printing function, which is the function of performing printing based on a print job. Each of the printing devices 120A to 120D may include at least one of a scanner function and a fax function in addition to the printing function. A printing device having a plurality of functions in this way may be referred to as a multifunction printer (MFP). Alternatively, the printing devices 120A to 120D may be a single function peripheral (SFP) having only the printing function. Printing may be printing onto a sheet-like recording medium such as paper, or molding of a three-dimensional object (so-referred to as three-dimensional printing).

The print server 130 provides a print service through which a print job is transmitted to any of the printing devices (e.g., the printing device 120A) according to the print job generated by the information processing device 110. For example, the print server 130 provides a logical printer to the information processing device 110 and accepts a print job for the logical printer. The logical printer is a virtual printing device (e.g., a printer object) provided by the print server 130. The logical printer may also be referred to as a cloud printer. The information processing device 110 can generate a print queue for the logical printer as well as for the printing device 120D. In contrast to the logical printer, the physical printing devices such as the printing devices 120A to 120D may also be referred to as physical printers. In the following description, logical printers and physical printers are collectively referred to simply as printers. When a physical printer is connected to the same LAN as the information processing device that submits a print job, the physical printer may also be referred to a local printer.

The print server 130 may be a server in an on-premises environment connected to the wide area network 103, or a server in a cloud computing environment (hereinafter simply referred to as cloud). The print service provided by the print server 130 in the cloud may be referred to as a cloud print service. One example of a cloud print service is Universal Print (registered trademark) provided by Microsoft Corporation. The cloud print service may be made available to a user by the user logging in to the cloud print service. For example, Universal Print is conjunctively logged in by a user when the user logs in to Azure Active Directory provided by Microsoft Corporation. The following describes a case where the print server 130 is located in a cloud. However, the following description is also applicable to a case where the print server 130 is located in an on-premises environment.

The information processing device 110 provides a printing function to a user of the information processing device 110. The information processing device may be a personal computer (PC), a smartphone, or another device. The information processing device 110 may specify a physical printer (e.g., the printing device 120D) connected to the same LAN 101 as the output destination, or may specify a logical printer provided by the print server 130 as the output destination. When a logical printer is specified as the output destination, the physical printer associated with the logical printer (e.g., the printing device 120A) performs printing. The information processing device 110 that uses the cloud print service may be referred to as a client or a client terminal. Printing performed in response to a print job submitted to a logical printer may also be referred to as cloud print, remote print, or remote printing. Printing through cloud print may be performed by the printing device 120D connected to the same LAN 101 as the information processing device 110, or may be performed by a printing device not connected to the LAN 101 (e.g., the printing device 120A). Printing performed in response to a print job directly submitted to a physical printer (i.e., within a LAN) may also be referred to as local print or local printing.

The information processing device 110 may have a printing function that is included in an operating system (OS) by default. Such a printing function is referred to as a standard printing function. The standard printing function may also be referred to as an OS standard printing function or a native printing function. The information processing device 110 having the standard printing function does not require separate software (e.g., a driver) to use a printing device that supports the standard printing function. Examples of standard printing functions include AirPrint (registered trademark), which is included in iOS, macOS (registered trademark), or the like by default, and Mopria (registered trademark), which is included in Android by default.

### Example of Hardware Configuration of Computer

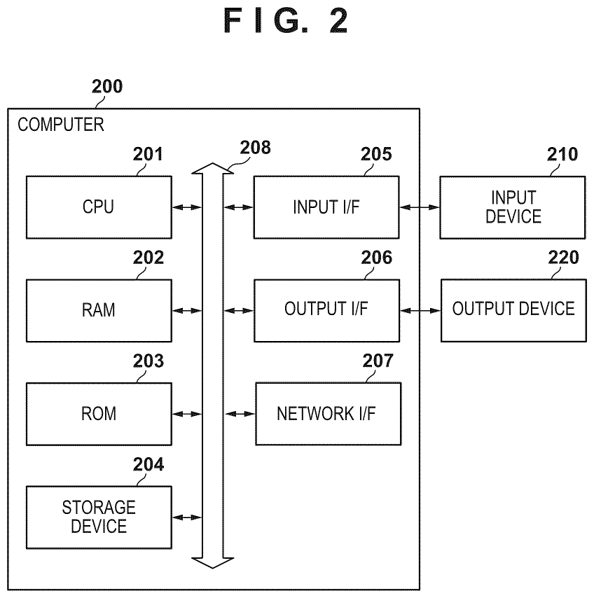

An example of a hardware configuration of a computer 200 according to same embodiments will be described with reference to FIG. 2. The computer 200 may be used as the information processing device 110 or the print server 130. The computer 200 may include the components shown in FIG. 2.

A central processing unit (CPU) 201 is a general-purpose processing circuit that controls the overall operation of the computer 200. A random access memory (RAM) 202 is a volatile memory circuit and is used as a temporary storage area such as a work area for processing by the CPU 201. A read-only memory (ROM) 203 is a non-volatile memory circuit and stores programs and data used in processing performed by the CPU 201. A storage device 204 is a non-volatile storage device and stores programs and data used in processing performed by the CPU 201. The storage device 204 may be, for example, a hard disk drive (HDD) or a solid state drive (SSD). The storage device 204 may also be referred to as a secondary storage device. The operations of the computer 200 may be realized by the CPU 201 executing a program read out from the storage device 204 to the RAM 202.

An input interface (I/F) 205 is an I/F for exchanging signals with an input device 210. The input device 210 is a device that acquires an input from a user of the computer 200. The input device 210 may be, for example, a keyboard, a touch panel, a microphone, a mouse, or any combination thereof. An output I/F 206 is an I/F for exchanging signals with an output device 220. The output device 220 is a device that provides information to a user of the computer 200. The output device 220 may be, for example, a display, a speaker, or any combination thereof. A network I/F 207 is an I/F for communicating with devices external to the computer 200. The CPU 201, the RAM 202, the ROM 203, the storage device 204, the input I/F 205, the output I/F 206, and the network I/F 207 are each connected to a system bus 208. In the example in FIG. 2, the input device 210 and the output device 220 are shown as separate devices from the computer 200. Alternatively, the computer 200 may include the input device 210 and the output device 220.

### Example of Functional Configuration of Print Server

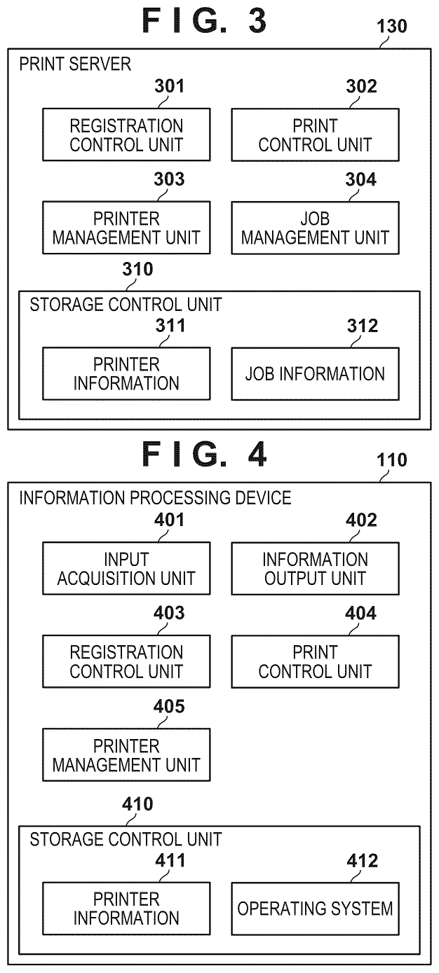

An example of a functional configuration of the print server 130 will be described with reference to FIG. 3. The print server 130 may include the functional units shown in FIG. 3. The print server 130 may also include functional units not shown in FIG. 3. Each functional unit in FIG. 3 may be realized by the CPU 201 executing a program read into the RAM 202. Alternatively, some or all of the functional units in FIG. 3 may be realized by a dedicated processing circuit such as an application specific integrated circuit (ASIC).

A registration control unit 301 performs processing to register a logical printer. For example, in response to a registration start request from a printing device, the registration control unit 301 generates a logical printer associated with the physical printer and registers it in printer information 311. The logical printer registered in the printer information 311 is recognized as a printer by the information processing device 110. The physical printer associated with a logical printer may be a physical printer that performs printing according to a print job submitted to the logical printer. The logical printer may be associated with only one physical printer. The physical printer may be associated with only one logical printer or with a plurality of logical printers.

A print control unit 302 performs processing related to print jobs for logical printers. For example, the print control unit 302 receives a print job for a logical printer from the information processing device 110 and, based on this, transmits the print job to a physical printer associated with the logical printer. The print control unit 302 may also control events related to print jobs. Examples of events related to print jobs may include receiving a print job. In response to receiving an event request from a physical printer, the print control unit 302 may respond with an event related to the physical printer.

A printer management unit 303 manages information regarding the logical printers registered in the print server 130 as the printer information 311. The printer information 311 includes information regarding the capabilities of the physical printer associated with a logical printer, a cloud printer ID that is uniquely assigned to the logical printer, and information regarding the print queue in which print jobs are spooled.

A job management unit 304 manages information regarding print jobs received from the information processing device 110 as job information 312. The job information 312 includes information and statuses of print jobs, print data specified in the print jobs, and so on.

A storage control unit 310 stores information in the RAM 202 or the storage device 204, and reads information from the RAM 202 or the storage device 204, in accordance with instructions from other functional units. According to some embodiments, the storage control unit 310 stores the printer information 311 and the job information 312.

### Example of Functional Configuration of Information Processing Device

An example of a functional configuration of the information processing device 110 will be described with reference to FIG. 4. The information processing device 110 may include the functional units shown in FIG. 4. The information processing device 110 may also include functional units not shown in FIG. 4. Each functional unit in FIG. 4 may be realized by the CPU 201 executing a program read into the RAM 202. Alternatively, some or all of the functional units in FIG. 4 may be realized by a dedicated processing circuit such as an ASIC.

An input acquisition unit 401 acquires an input from a user of the information processing device 110 using the input I/F 205. An information output unit 402 outputs information to a user of the information processing device 110 using the output I/F 206.

A registration control unit 403 performs processing to register a logical printer in the print server 130. A print control unit 404 performs processing related to printing performed by printers. For example, the print control unit 404 may transmit a print job to a logical printer registered in the print server 130 in accordance with a print instruction from a user of the information processing device 110. The print control unit 404 may transmit a print job directly to a physical printer (i.e., within the same LAN) in accordance with a print instruction from a user of the information processing device 110.

A printer management unit 405 manages, as printer information 411, information regarding printers to which the information processing device 110 can submit print jobs. The printer information 411 includes information such as the capabilities of printers. The printer management unit 405 may search for printers to which the information processing device 110 can submit print jobs.

A storage control unit 410 stores information in the RAM 202 or the storage device 204, and reads information from the RAM 202 or the storage device 204, in accordance with instructions from other functional units. According to some embodiments, the storage control unit 410 stores the printer information 411 and an operating system 412. The operating system 412 is installed in the information processing device 110 by default (i.e., when the information processing device 110 is shipped). The operating system 412 may be updated. The operating system 412 has a function for basic management and control of the information processing device 110. As described above, the operating system 412 may include the standard printing function.

### Example of Hardware Configuration of Printing Device

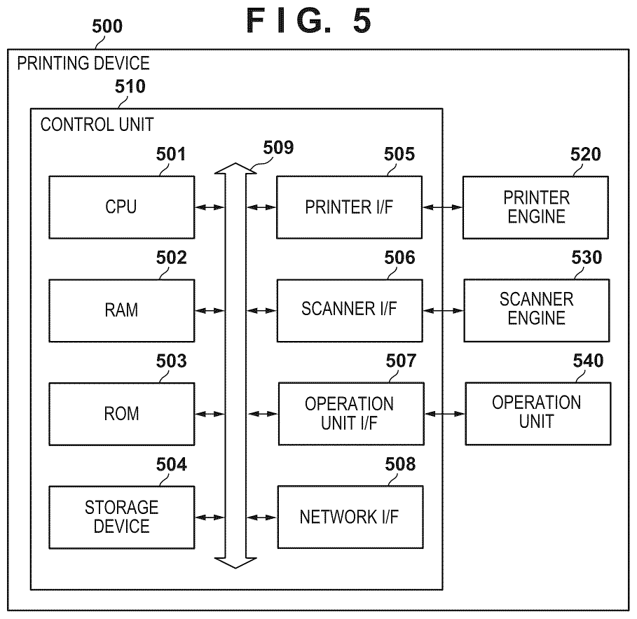

An example of a hardware configuration of a printing device 500 according to same embodiments will be described with reference to FIG. 5. The printing device 500 may be used as any of the printing devices 120A to 120D. The printing device 500 may include the components shown in FIG. 5. Since the printing device 500 is a physical printing device, it may also be referred to as a physical printer.

A CPU 501 is a general-purpose processing circuit that controls the overall operation of the printing device 500. A RAM 502 is a volatile memory circuit and is used as a temporary storage area such as a work area for processing performed by the CPU 501. A ROM 503 is a non-volatile memory circuit and stores programs and data used in processing performed by the CPU 501. A storage device 504 is a non-volatile storage device and stores programs (e.g., print jobs, image data, and setting information) and data used in processing performed by the CPU 501. The storage device 504 may be, for example, an HDD or an SSD. The storage device 504 may also be referred to as a secondary storage device. The operations of the printing device 500 may be realized by the CPU 501 executing a program read out from the storage device 504 to the RAM 502.

A printer I/F 505 is an I/F for exchanging signals with a printer engine 520. The printer engine 520 performs printing based on a signal (e.g., an image signal or a print command) supplied from a control unit 510 via the printer I/F 505. Printing may be electrophotographic printing, in which toner is transferred to and fixed on paper, inkjet printing, in which ink is ejected onto paper, or three-dimensional printing.

A scanner I/F 506 is an I/F for exchanging signals with a scanner engine 530. The scanner engine 530 supplies a signal (e.g., an image signal) acquired by reading a document to the control unit 510 via the scanner I/F 506. The CPU 501 may process the image signal supplied from the scanner engine 530 and supply the recording image signal thus obtained to the printer engine 520. The CPU 501 may generate image data based on an image signal supplied from the scanner engine 530 and transmit the image data to an external device.

An operation unit I/F 507 is an I/F for exchanging signals with an operation unit 540. The operation unit 540 is a device that acquires input from a user of the printing device 500 and provides information to the user of the printing device 500. The operation unit 540 may be constituted by, for example, a display panel (e.g., a liquid crystal display), a speaker, a touch panel, a keyboard, a button, a touch screen, or any combination thereof.

A network I/F 508 is an I/F for communicating with devices external to the printing device 500. The CPU 501, the RAM 502, the ROM 503, the storage device 504, the printer I/F 505, the scanner I/F 506, the operation unit I/F 507, and the network I/F 508 constitute the control unit 510. Each component included in the control unit 510 is connected to a system bus 509.

### Example of Functional Configuration of Printing Device

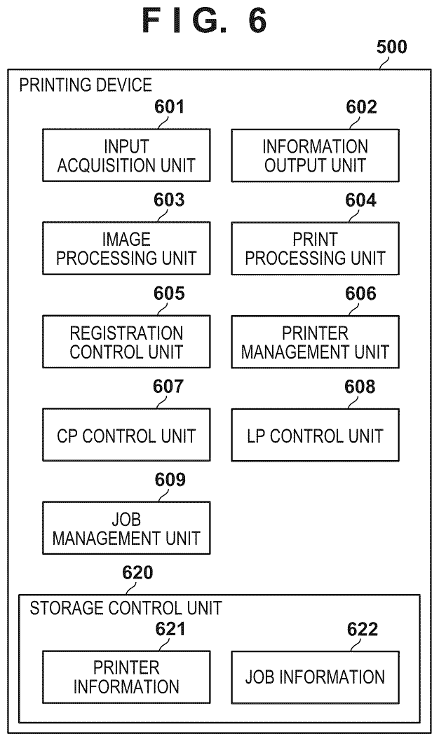

An example of a functional configuration of the printing device 500 will be described with reference to FIG. 6. The printing device 500 may include the functional units shown in FIG. 6. The printing device 500 may also include functional units not shown in FIG. 6. Each functional unit in FIG. 6 may be realized by the CPU 501 executing a program read into the RAM 502. Alternatively, some or all of the functional units in FIG. 6 may be realized by a dedicated processing circuit such as an ASIC.

An input acquisition unit 601 acquires an input from a user of the printing device 500 using the operation unit I/F 507. An information output unit 602 outputs information to a user of the printing device 500 using the operation unit I/F 507. For example, the information output unit 602 displays an operation menu on the operation unit 540. The input acquisition unit 601 acquires an input to the operation menu and notifies other functional units of the content of the input instruction. The information output unit 602 outputs results acquired from the other functional units on the operation unit 540.

An image processing unit 603 renders print jobs into image data for printing. A print processing unit 604 prints the image data rendered by the image processing unit 603.

A registration control unit 605 performs processing to register a logical printer associated with the printing device 500 in the print server 130. A printer management unit 606 manages information regarding the printing device 500 as the printer information 621. The printer information 621 may include, for example, the status of the printing device 500, the capabilities of the printing device 500, and a cloud printer ID that is uniquely assigned by the print server 130 to the logical printer associated with the printing device 500. The printer information 621 may also include a local printer ID that enables the information processing device 110 to identify a printing device within the same LAN 101.

A cloud print (CP) control unit 607 performs processing related to cloud print. For example, the CP control unit 607 may transfer print data included in a print job received from the print server 130 to the image processing unit 603, thereby executing printing according to the print job transmitted from the print server 130. The CP control unit 607 may also transmit an event request to the print server 130.

A local print (LP) control unit 608 performs processing related to local printing. For example, the LP control unit 608 may respond to a printer search from the information processing device 110. In addition, the LP control unit 608 may execute printing according to a print job transmitted from the information processing device 110 by transferring print data included in the print job received directly from the information processing device 110 to the image processing unit 603. A job management unit 609 manages information regarding print jobs as job information 622. The job information 622 may include the processing status and processing results of a print job.

A storage control unit 620 stores information in the RAM 502 or the storage device 504, and reads information from the RAM 502 or the storage device 504, in accordance with instructions from other functional units. According to some embodiments, the storage control unit 620 stores the printer information 621 and the job information 622. The storage control unit 620 may manage data as a file system. The storage control unit 620 may allocate the storage destination of each piece of data between the storage device 504, which is a non-volatile area, and the RAM 502, which is a volatile area. For example, the storage control unit 620 may store the printer information 621 and the job information 622 in the non-volatile area.

### Overall Processing Sequence for Cloud Print

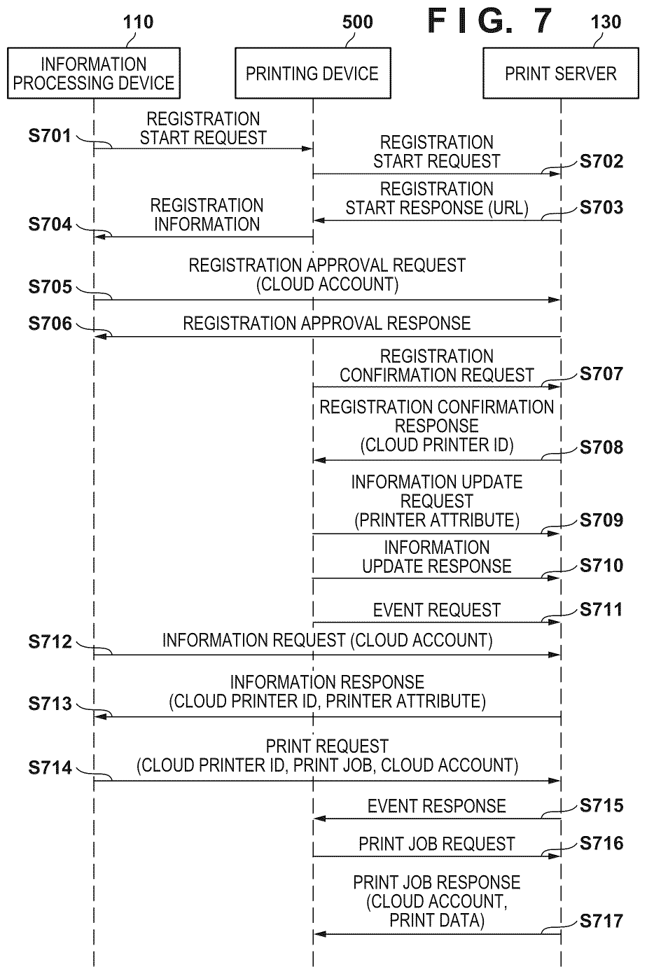

An overall processing sequence for performing cloud print will be described with reference to FIG. 7. The example in FIG. 7 addresses a case where the information processing device 110 registers the printing device 500 in the print server 130 and a print job is submitted to a logical printer associated with the printing device 500. The following description of the printing device 500 may also be applied to the printing devices 120A to 120D. Registering the printing device 500 in the print server 130 may be registering a logical printer associated with the printing device 500 in the print server 130. In the following example, it is assumed that the printing device 500 supports a web user interface (UI) function for operating the printing device 500 from the information processing device 110. It is also assumed that the information processing device 110 supports a web UI client function. The mutual communication between the information processing device 110, the printing device 500, and the print server 130 may be performed using the Internet Printing Protocol (IPP).

In step S701, the registration control unit 403 of the information processing device 110 transmits a registration start request to the printing device 500 in accordance with an instruction from a user of the information processing device 110. The registration start request may be a request to start processing to register the printing device 500 in the print server 130. The registration start request may be transmitted using the web UI client function of the information processing device 110.

In step S702, in response to receiving the registration start request from the information processing device 110, the registration control unit 605 of the printing device 500 transmits a registration start request to the print server 130. The registration start request may be a request to start processing to register the printing device 500 in the print server 130.

In step S703, in response to receiving the registration start request from the printing device 500, the registration control unit 301 of the print server 130 transmits a registration start response to the printing device 500. The registration start response includes a uniform resource locator (URL) of a web page for the user of the information processing device 110 to input information for registering the printing device 500 in the print server 130.

In step S704, in response to receiving the registration start response from the print server 130, the registration control unit 605 of the printing device 500 transmits registration information to the information processing device 110. The registration information includes the URL included in the registration start response. In response to receiving the registration information from the printing device 500, the information output unit 402 of the information processing device 110 displays the web page to the user.

In step S705, in response to the user of the information processing device 110 accessing the URL and inputting information required for registration, the registration control unit 403 of the information processing device 110 transmits a registration approval request to the print server 130. The registration approval request includes a cloud account of the user of the information processing device 110. The cloud account is an account for the user to use a cloud tenant that includes the print server 130.

In step S706, the registration control unit 301 of the print server 130 checks whether or not the cloud account included in the registration approval request belongs to a user who is authorized to register the printing device 500 in the print server 130. If the user is authorized, the registration control unit 301 of the print server 130 transmits a registration approval response to the information processing device 110. The registration approval response may be a message reporting the result of the check indicating that the user of the information processing device 110 is a user authorized to register the printing device 500.

In step S707, in response to receiving the registration start response from the print server 130, the printer management unit 606 of the printing device 500 transmits a registration confirmation request to the print server 130. The registration confirmation request is a request related to the registration of the printing device 500 in the print server 130, and may specifically be a request to register the printing device 500 in the print server 130.

In step S708, in response to receiving the registration confirmation request from the printing device 500, the printer management unit 303 of the print server 130 generates a new logical printer, and adds the logical printer to the printer information 311 in association with the printing device 500. As a result, the printing device 500 is registered in the print server 130, and the information processing device 110 can perform cloud print using the logical printer. In addition, the printer management unit 303 of the print server 130 assigns a unique cloud printer ID to the generated logical printer, and adds the cloud printer ID to the printer information 311 in association with the logical printer. Thereafter, the registration control unit 301 of the print server 130 transmits a registration confirmation response to the printing device 500. The registration confirmation response includes the cloud printer ID of the printing device 500.

In step S709, in response to the registration of the printing device 500 in the print server 130 being complete, the printer management unit 606 of the printing device 500 transmits an information update request to the print server 130. The information update request may be a request to update information regarding the printing device 500. The information update request includes printer attributes of the printing device 500. The information update request may be transmitted in the form of an update-output-device-attributes request message defined in the IPP.

In step S710, the printer management unit 303 of the print server 130 updates the information regarding the printing device 500 included in the printer information 311 based on the printer attributes included in the received information update request, and transmits an information update response to the printing device 500. The information update response may be a message reporting that the update of the information regarding the printing device 500 has been successfully completed.

In step S711, in response to receiving the registration confirmation response from the print server 130, the CP control unit 607 of the printing device 500 transmits an event request to the print server 130. The event request may be a request to notify the printing device 500 when an event related to the printing device 500 occurs. The event request may relate to an event where a print job is submitted to a logical printer associated with the printing device 500.

In step S712, the printer management unit 405 of the information processing device 110 transmits an information request to the print server 130 in response to a request from the user of the information processing device 110. The information request may be a request for information regarding a logical printer available to the user of the information processing device 110. The information request includes the cloud account of the user of the information processing device 110. The information request may be transmitted in the form of a Get-Printer-Attributes Request message defined in the IPP.

In step S713, in response to receiving the information request from the information processing device 110, the printer management unit 303 of the print server 130 transmits an information response to the information processing device 110. The information response includes a cloud printer ID and printer attributes for each of one or more logical printers available to the user of the information processing device 110. The printer management unit 405 of the information processing device 110 updates the printer information 411 based on the information response. As a result, the discovered logical printers are registered in the standard printing function of the information processing device 110. The information response may be transmitted in the form of a Get-Printer-Attributes Response message defined in the IPP.

In step S714, the printer management unit 405 of the information processing device 110 transmits a print request to the print server 130 in accordance with an instruction from the user of the information processing device 110. The print request includes a cloud printer ID, a print job, and the cloud account of the user of the information processing device 110. The print job may include print data and print settings. The print request may be a request to print the print data included in the print request to a logical printer that has the cloud printer ID included in the print request. The information processing device 110 may instruct a logical printer registered in the standard printing function to perform printing.

In step S715, in response to receiving the print request from the information processing device 110, the print control unit 302 of the print server 130 transmits an event response to the printing device 500 associated with the logical printer. The event response is a response to the event request received in step S711. The event response is a response for reporting that an event of the type specified in the event request has occurred.

In step S716, in response to receiving the event response from the print server 130, the CP control unit 607 of the printing device 500 transmits a print job request to the print server 130. The print job request may be a request for a print job to be executed by the printing device 500.

In step S717, in response to receiving the print job request from the printing device 500, the print control unit 302 of the print server 130 transmits a print job response to the printing device 500. The print job response includes the cloud account and the print job. Thereafter, in response to receiving the print job response from the print server 130, the printing device 500 performs printing based on the print job. The print job response received by the printing device 500 from the print server 130 may be a Fetch-Job Response defined in the IPP.

In the illustration in FIG. 7, the registration of the printing device 500 in steps S701 to S706 and the cloud print in steps S712 to S717 may be performed by the same user or by different users.

### Overall Processing Sequence for Local Print

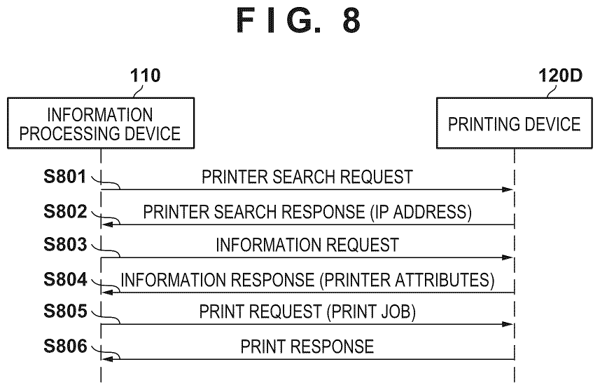

An overall processing sequence for performing local print will be described with reference to FIG. 8. The example in FIG. 8 addresses a case where the information processing device 110 submits a print job to the printing device 120D that is connected to the same network (i.e., the LAN 101) as the information processing device 110. The communication between the information processing device 110 and the printing device 120D may be performed using the IPP. The communication between the information processing device 110 and the printing device 120D is performed within the LAN 101 and does not go through the wide area network 103. The following example describes an example where the information processing device 110 has AirPrint as a standard printing function, and local printing is performed using AirPrint. A similar description may also be applied to a case where the information processing device 110 has Mopria or another standard printing function. It is assumed that the printing device 120D supports Airprint.

In step S801, using Airprint, the printer management unit 405 of the information processing device 110 transmits a printer search request to the network to which the information processing device 110 is connected (i.e., the LAN 101) in accordance with an instruction from the user of the information processing device 110. This printer request search may be performed by broadcasting to the LAN 101. The printer search request may be a request for a response as to whether or not a printer that supports AirPrint is present.

In step S802, the LP control unit 608 of the printing device 120D that supports AirPrint transmits a printer search response to the information processing device 110 in response to the printer search request. The printer search response may include the Internet Protocol (IP) address of the printing device 120D. Printing devices that do not support Airprint, or printing devices that have Airprint disabled, do not have to respond to the printer request search. The printer management unit 405 of the information processing device 110 stores the IP address of the printing device 120D that transmitted the printer search response, in the storage control unit 410 as a part of the printer information 411. As a result, the discovered printing device 120D is registered in Airprint. The information output unit 402 of the information processing device 110 may present a list of discovered printing devices to the user.

In step S803, the printer management unit 405 of the information processing device 110 transmits an information request to the printing device 120D. The information request may be a request for information regarding the printing device 120D. The information request may be transmitted in the form of a Get-Printer-Attributes Request message defined in the IPP.

In step S804, in response to receiving the information request from the information processing device 110, the printer management unit 606 of the printing device 120D transmits an information response to the information processing device 110. The information response includes printer attributes of the printing device 120D. The printer management unit 405 of the information processing device 110 updates the printer information 411 based on the information response. The information response may be transmitted in the form of a Get-Printer-Attributes Response message defined in the IPP.

In step S805, the print control unit 404 of the information processing device 110 transmits a print request to the printing device 120D in accordance with an instruction from the user of the information processing device 110. The print request includes a print job. The print job may include print data and print settings. The print request may be a request to print the print data included in the print request to the printing device 120D.

In step S806, the LP control unit 608 of the printing device 120D executes printing in accordance with the received print job. The LP control unit 608 of the printing device 120D transmits the result of the printing to the information processing device 110 as a print response.

### Operation Flow through which Information Processing Device perform Printer Search

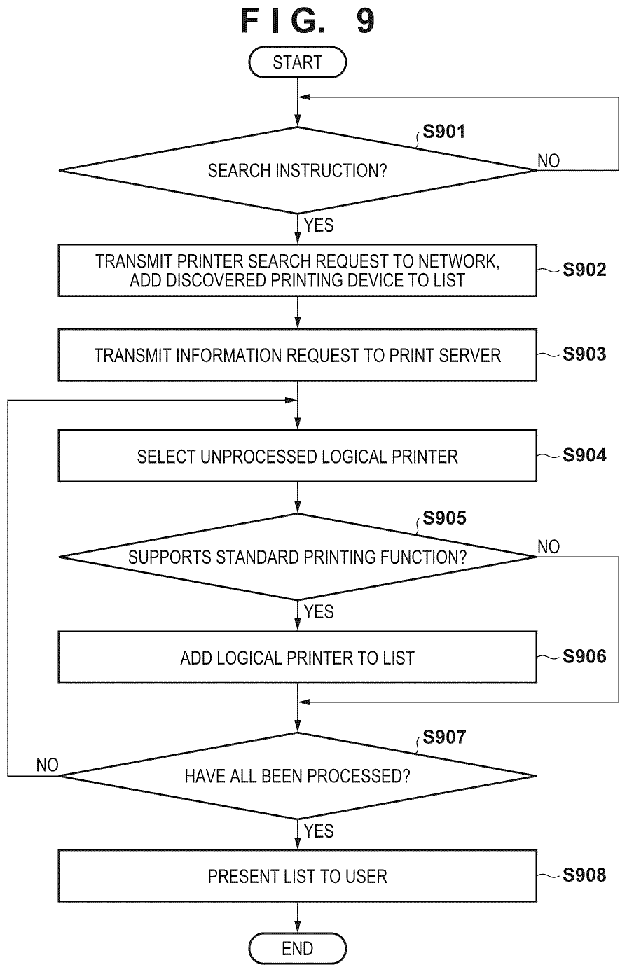

An example of processing through which the information processing device 110 searches for a printer that supports the standard printing function of the information processing device 110 will be described with reference to FIG. 9. The operation in FIG. 9 may be performed continuously while the information processing device 110 is in operation.

In step S901, the printer management unit 405 of the information processing device 110 determines whether or not an instruction to search for a printer has been acquired from the user of the information processing device 110. If it is determined that an instruction to search for a printer has been acquired (“YES” in S901), the information processing device 110 moves processing to step S902, and otherwise (“NO” in S901), repeats step S901.

In step S902, using the standard printing function of the information processing device 110 in the same manner as in step S801 described above, the printer management unit 405 of the information processing device 110 transmits a printer search request to the network to which the information processing device 110 is connected (i.e., the LAN 101). The printer management unit 405 of the information processing device 110 adds the printing device that responded to the printer search request to the printer list. This printer list lists printers that support the standard printing function of the information processing device 110. Any printing device that responds to a printer search request using the standard printing function supports the standard printing function.

In step S903, in the same manner as in step S712 described above, the printer management unit 405 of the information processing device 110 transmits an information request to the print server 130. The information request may be a request for information regarding a logical printer available to the user of the information processing device 110. In the same manner as in step S713 described above, the print server 130 presents, to the information processing device 110, an information response including information regarding one or more logical printers that are available to the information processing device 110. These one or more logical printers may include a logical printer that is associated with a printing device that supports the standard printing function of the information processing device 110.

In step S904, the printer management unit 405 of the information processing device 110 selects one logical printer that has not yet been selected as a target for the subsequent processing in steps S905 to S906 from among the one or more logical printers included in the information response from the print server 130. If the information response does not include any logical printers, the processing in steps S905 and S906 is skipped.

In step S905, the printer management unit 405 of the information processing device 110 determines whether or not the selected logical printer supports the standard printing function of the information processing device 110. If it is determined that the selected logical printer supports the standard printing function of the information processing device 110 (“YES” in S905), the printing device 500 moves processing to step S906, and otherwise (“NO” in S905) moves processing to step S907. Whether or not the selected logical printer supports the standard printing function of the information processing device 110 may be determined based on the printer attributes included in the information response.

In step S906, the printer management unit 405 of the information processing device 110 adds the selected logical printer to the printer list. As a result, the selected logical printer is registered in the standard printing function of the information processing device 110. In step S907, the printer management unit 405 of the information processing device 110 determines whether or not all of the one or more logical printers included in the information response have been selected. If it is determined that all of the logical printers have been selected (“YES” in S907), the printing device 500 moves processing to step S908, and otherwise (“NO” in S907) the printing device 500 moves processing to step S904. In this manner, the processing in steps S905 and S906 are performed for each of the one or more logical printers included in the information response.

In step S908, the information output unit 402 of the information processing device 110 presents the printer list, which is the result of the inquiry, to the user. The printer list includes both printing devices that are connected to the same network as the information processing device 110 and that support the standard printing function of the information processing device 110 and logical printers that support the standard printing function of the information processing device 110. In this way, the user can search for various printers to which the information processing device 110 can submit a print job, using a single operation (the search instruction in S901).

In the example in FIG. 9, steps S903 to S907 are performed after step S902. Alternatively, steps S903 to S907 may be performed before step S902, steps S903 to S907 may be performed in parallel with step S902.

### Screens Provided By Standard Printing Function

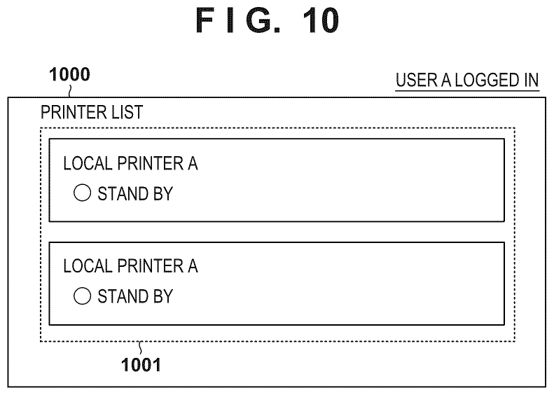

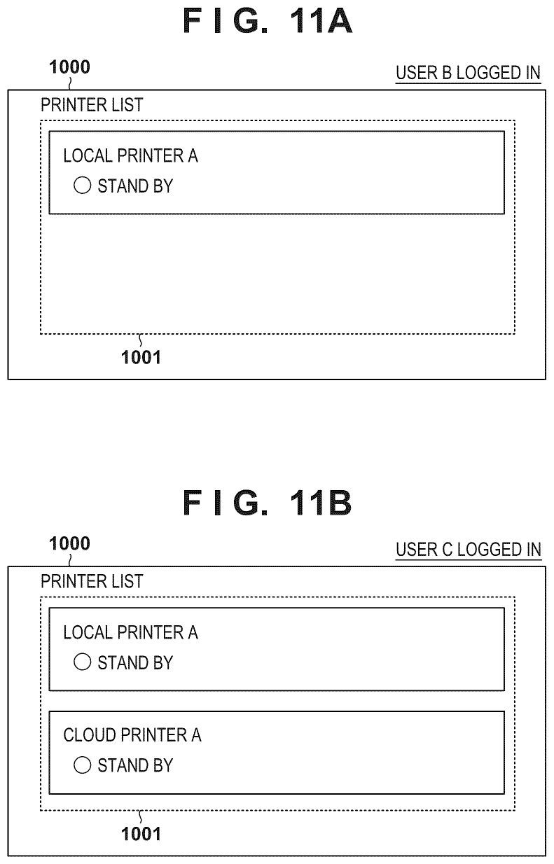

Examples of screens provided by the standard printing function will be described with reference to FIGS. 10 to 11B. The standard printing function may generate a list screen 1000 including a list of printers registered in the standard printing function, and display it on the output device 220. An example of the list screen 1000 will be described with reference to FIG. 10. The list screen 1000 may include the objects shown in FIG. 10, or include objects other than the objects shown in FIG. 10, or not include some of the objects shown in FIG. 10. The same applies to other screens described below. The display of the list screen 1000 may be started in response to a user instruction to display the list screen 1000, or in response to an automatic transition from another screen.

The list screen 1000 includes a list 1001 of printers registered in the standard printing function. The list 1001 may include one or more cloud printers that are registered in the standard printing function and one or more local printers that are registered in the standard printing function. If no cloud printers are registered in the standard printing function, no cloud printers are included in the list 1001. If no local printers are registered in the standard printing function, no local printers are included in the list 1001. The list 1001 may include information regarding each printer. In the example in FIG. 10, the name and status of each printer are displayed as information regarding the printer.

It is assumed that both the local printer (“local printer A”) and the cloud printer (“cloud printer A”) included in the list 1001 on the list screen 1000 in FIG. 10 have been registered in the standard printing function by a specific user (“user A” in the example in FIG. 10). For example, the printer management unit 405 of the information processing device 110 may store the identifier of the user who has registered the cloud printer in association with the cloud printer in the printer information 411. The user who has registered the printer may be a user who is logged in to the information processing device 110 when printer registration processing (for example, the method shown in FIG. 9) is performed.

The information output unit 402 of the information processing device 110 may display, in the list 1001, information regarding the cloud printer (“cloud printer A”) registered in the standard printing function by the user A while the user A is logged in to the information processing device 110. Furthermore, the information output unit 402 of the information processing device 110 may display information regarding the local printer (“local printer A”) registered in the standard printing function in the list 1001 while the user A is logged in to the information processing device 110. The local printer displayed while the user A is logged in to the information processing device 110 may be a local printer registered by the user A or a local printer not registered by the user A.

An example of the list screen 1000 displayed while the user different from the user A is logged in to the information processing device 110 will be described with reference to FIGS. 11A and 11B. FIG. 11A illustrates an example of the list screen 1000 displayed while a user B different from the user A is logged in to the information processing device 110. The user B may be a user who does not belong to the same tenant as the user A. For example, the user B may belong to a tenant different from the user A, or may not belong to any tenant.

The information output unit 402 of the information processing device 110 may not display information regarding a cloud printer registered in the standard printing function by the user A but not registered in the standard printing function by the user B in the list 1001 while the user B is logged in to the information processing device 110. For example, when the cloud printer A registered by the user A is not registered by the user B, information regarding the cloud printer A is not displayed while the user B is logged in to the information processing device 110. In this way, by not displaying the information regarding the cloud printer A to the user B, it is possible to prevent the user B from trying to use the unavailable cloud printer A. If the cloud printer A is registered in the standard printing function by not only the user A but also the user B, information regarding the cloud printer A may be displayed while the user B is logged in to the information processing device 110.

Furthermore, the information output unit 402 of the information processing device 110 may display information regarding the local printer (“local printer A”) registered in the standard printing function in the list 1001 while the user B is logged in to the information processing device 110. The local printer displayed while the user B is logged in to the information processing device 110 may be a local printer registered by the user B or a local printer not registered by the user B.

FIG. 11B illustrates an example of the list screen 1000 displayed while a user C different from the user A is logged in to the information processing device 110. The user C may be a user who belongs to the same tenant as the user A.

The information output unit 402 of the information processing device 110 may display, in the list 1001, information regarding a cloud printer registered in the standard printing function by the user A and not registered in the standard printing function by the user C while the user C is logged in to the information processing device 110. For example, when the cloud printer A registered by the user A is not registered by the user C, information regarding the cloud printer A is displayed while the user C is logged in to the information processing device 110. In this way, the registration status of a cloud printer may be shared among a plurality of users belonging to the same tenant. The cloud printer A may be registered in the standard printing function by not only the user A but also the user C.

Furthermore, the information output unit 402 of the information processing device 110 may display information regarding the local printer (“local printer A”) registered in the standard printing function in the list 1001 while the user C is logged in to the information processing device 110. The local printer displayed while the user C is logged in to the information processing device 110 may be a local printer registered by the user C or a local printer not registered by the user C.

In the above-described embodiment, the registration status of a cloud printer is shared among a plurality of users who belong to the same tenant. Alternatively, if a user has not registered a cloud printer in the standard printing function on his or her own, the information output unit 402 of the information processing device 110 may not display information regarding the cloud printer in the list 1001.

In the above-described examples, the list screen 1100 has been described as an example of a screen used to display information regarding a cloud printer. Additionally, or alternatively, similar processing may be performed on a screen that displays information regarding a cloud printer (for example, a screen used to select the printer that is to perform printing).

As described above, according to various embodiments of the present invention, information regarding a cloud printer that is not registered by a user on his or her own or by another user belonging to the same tenant as the user is not displayed. As a result, it is possible to prevent unnecessary information regarding a cloud printer from being displayed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-143919, filed Sep. 5, 2023, which is hereby incorporated by reference herein in its entirety.

What is claimed is:

1. An information processing device having an operating system (OS) standard printing function, the information processing device comprising:
a display unit configured to display information regarding a cloud printer registered in the OS standard printing function; and
a print unit configured to instruct a cloud printer registered in the OS standard printing function to perform printing, wherein
while a first user is logged in to the information processing device, the display unit displays information regarding a cloud printer registered in the OS standard printing function by the first user, and
while a second user different from the first user is logged in to the information processing device, the display unit does not display information regarding a cloud printer registered in the OS standard printing function by the first user and not registered in the OS standard printing function by the second user.

2. The information processing device according to claim 1,
wherein the second user is a user who does not belong to the same tenant as the first user.

3. The information processing device according to claim 1,
wherein while a third user belonging to the same tenant as the first user is logged in to the information processing device, the display unit displays information regarding a cloud printer registered in the OS standard printing function by the first user and not registered in the OS standard printing function by the third user.

4. The information processing device according to claim 1,
wherein while the second user is logged in to the information processing device, the display unit displays information regarding a local printer registered in the OS standard printing function by the first user and not registered in the OS standard printing function by the second user.

5. The information processing device according to claim 1,
wherein the print unit uses the Internet Printing Protocol to instruct the cloud printer to perform printing.

6. A printing system comprising:
the information processing device according to claim 1;
a print server that provides the cloud printer; and
a printing device that is registered in the print server as the cloud printer.

7. A non-transitory storage medium that stores a program for enabling a computer to function as the units included in the information processing device according to claim 1.

8. A method for controlling an information processing device having an operating system (OS) standard printing function, comprising:
displaying information regarding a cloud printer registered in the OS standard printing function; and
instructing a cloud printer registered in the OS standard printing function to perform printing, wherein
while a first user is logged in to the information processing device, information regarding a cloud printer registered in the OS standard printing function by the first user is displayed, and
while a second user different from the first user is logged in to the information processing device, information regarding a cloud printer registered in the OS standard printing function by the first user and not registered in the OS standard printing function by the second user is not displayed.
